(19) United States
(12) Patent Application Publication
(10) Pub. No.: US 2013/0229794 A1
(43) Pub. Date: Sep. 5, 2013

(54) ILLUMINATING LIGHT SOURCE AND ILLUMINATING DEVICE

(71) Applicants: Masahiro Miki, Osaka (JP); Hideo Nagai, Osaka (JP); Takaari Uemoto, Osaka (JP); Mitsuko Shuto, Osaka (JP); Makoto Inoue, Hyogo (JP)

(72) Inventors: Masahiro Miki, Osaka (JP); Hideo Nagai, Osaka (JP); Takaari Uemoto, Osaka (JP); Mitsuko Shuto, Osaka (JP); Makoto Inoue, Hyogo (JP)

(73) Assignee: PANASONIC CORPORATION, Osaka (JP)

(21) Appl. No.: 13/884,699

(22) PCT Filed: Dec. 16, 2011
(86) PCT No.: PCT/JP2011/007039

§ 371 Date: May 10, 2013

(30) Foreign Application Priority Data
Dec. 16, 2010 (JP) 2010-280149

(51) Int. Cl. F21V 15/01

(52) U.S. Cl. CPC F21V 15/01
USPC 362/223

(57) ABSTRACT

Provided is a light source including a light-emitting element, an outer shell that houses therein the light-emitting element, and a base that is provided at the outer shell and receives power from the outside to cause the light-emitting element to emit light. The outer shell is electrically-insulative and light-transmissive. On at least part of the outer surface or the inner surface of the outer shell, an electrically-conductive member is provided. The electrically-conductive member is electrically connected to a grounding terminal of the lighting fixture. According to this structure, an electric charge stored on the outer surface can be discharged to the outside from the lighting fixture. This prevents the attachment of dust to the outer shell, and keeps the luminous flux close to the initial level for a long time period and reduces the amount of maintenance.

### TECHNICAL FIELD

The present invention relates to a light source including a light-emitting element.

### BACKGROUND ART

Compared to a conventional light source, light-emitting diodes (LEDs), which are semiconductor light-emitting elements, are small and efficient and have a long life. In addition, there are recent market needs for saving energy and resource. Therefore, these needs boost the demand for light sources using LEDs (hereinafter, such a light source is also simply referred to “LED light source”). Conventional light sources and LEDs are different in lighting principle, and are completely different in shape. However, there has been a demand for LED light sources having a similar appearance to the conventional light sources. In response to this demand, various LED light sources that substitute for light bulbs and fluorescent lamps have been commercialized.

LEDs are able to keep the luminous flux close to the initial level for a long time period, compared to the conventional light source such as a filament bulb and a fluorescent lamp. The use of a LED light source reduces the frequency of replacement, and it is therefore expected that the light source using the LED reduces maintenance costs.

Generally, in an LED light source, an LED disposed on a mount is covered with a light-transmissive outer shell made of glass or resin. Thus, the LED is protected by the outer shell and emits light through the outer shell to the outside.

### CITATION LIST

### Patent Literature

[Patent Literature 1]

Japanese Patent Application Publication No. 2009-43447
[Patent Literature 2]

Japanese Patent Application Publication No. 2004-187109

### SUMMARY OF INVENTION

### Technical Problem

Although the LED keeps the luminous flux close to the initial level, if dust attaches to the surface of the outer shell of the light source due to long use, such dust causes a reduction in luminous flux transmitted to the outside. Since the conventional light source with a short life is regularly replaced to a new one having no dust, such a problem has not been seriously considered.

However, even if an LED light source with a longer life than the conventional light source is used, the maintenance costs and frequency do not decrease as expected since it could be necessary to remove dust so as to prevent reduction of the luminous flux.

In addition, a conventional light source is driven by alternating current, and an electric field generated around the light source reverses its direction in the same cycle as the cycle of drive. In contrast, an LED is driven by direct current, and an electric field generated around the light source using the LED maintains a fixed direction. Such a condition also keeps the surface of the LED light source charged, and therefore dust attracted to the LED light source due to an electric charge is presumed to easily attach to the surface. In particular, it is believed that dust attracted due to an electric charge will be notable when an outer shell is formed of an electrically-insulative material such as glass, resin, etc.

The present invention has been achieved in view of the above problem, and an aim thereof is to provide a light source capable of preventing an electric charge from being stored on the outer surface of the outer shell and reducing the attachment of dust due to an electric charge.

### Solution to Problem

In order to the above problem, an aspect of a light source pertaining to the present invention provides a light source to be attached to a lighting fixture, comprising a light-emitting element; an outer shell that houses therein the light-emitting element; and a base provided at the outer shell, wherein the outer shell is electrically-insulative and light-transmissive, the outer shell has an electrically-conductive member provided on at least one of an outer surface and an inner surface thereof, and the electrically-conductive member is electrically connected to a grounding terminal of the lighting fixture.

Here, the expression “electrically connected” includes a case in which the electrically-conductive member and the grounding terminal are directly connected to each other and a case in which the electrically-conductive member and the grounding terminal are indirectly connected to each other. In addition, “base” is a component electrically connected to the lighting fixture, and may have a terminal for receiving power or a terminal for grounding (earthing), for example.

With such a structure, the light source is able to discharge an electric charge stored on the outer surface of the outer shell to the outside of the light source by using the electrically-conductive member. Thus, the light source is able to reduce the attachment of dust to the outer surface of the outer shell.

Further, according to an aspect of the light source pertaining to the present invention, electric resistance between the grounding terminal and a point on the electrically-conductive member that is electrically farthest from the grounding terminal is within a range from 1Ω to 1 MΩ.

With the above structure, a lower resistance value is able to prevent charge from being stored, and to reduce the attachment of dust due to an electrostatic charge.

Further, according to an aspect of the light source pertaining to the present invention, the electrically-conductive member is made of a light-transmissive metal oxide coating.

With the above structure, it is possible to suppress reduction in luminous flux caused by the electrically-conductive member.

Further, according to an aspect of the light source pertaining to the present invention, the electrically-conductive member is made of light-transmissive metal oxide particles.

With the above structure, it is possible to suppress the effect of reduction in luminous flux caused by the electrically-conductive member, and to cause the electrically-conductive member to perform the function of diffusing light.

Further, according to an aspect of the light source pertaining to the present invention, the electrically-conductive member is made of metal particles.

With the above structure, it is possible to easily provide the low resistance electrically-conductive member at the outer surface of the outer shell.

Further, according to an aspect of the light source pertaining to the present invention, the electrically-conductive member is made of metal.

With the above structure, it is possible to provide the low resistance electrically-conductive member at the outer surface of the outer shell.

Further, the electrically-conductive member has a function of diffusing light.

With the above structure, it is possible to diffuse light emitted by the light-emitting element.

Further, according to an aspect of the light source pertaining to the present invention, the electrically-conductive member is made of a transparent conductive film.

With the above structure, it is possible to increase productivity, and when the outer shell breaks, to prevent the broken pieces of the outer shell from scattering around.

Further, the electrically-conductive member includes a light-transmissive metal oxide coating and a strip-like conductive coating, the light-transmissive metal oxide coating being provided at a certain area of the outer surface of the outer shell to which the base is not attached, and the strip-like conductive coating being arranged in a longitudinal direction of the outer shell on an upper surface of the light-transmissive metal oxide coating.

With the above structure, it is possible to effectively discharge an electric charge stored on the entire outer surface of the outer shell to the outside.

Further, the base includes a grounding terminal connected to the grounding terminal of the lighting fixture, and the electrically-conductive member is connected to the grounding terminal of the base.

With the above structure, it is possible to reliably electrically connect the electrically-conductive member and the grounding terminal of the lighting fixture to each other.

Further, one aspect of the light source pertaining to the present invention provides a lighting apparatus comprising a light source and a lighting fixture to which the light source is detachably attached, wherein the light source is the light source of any one of Claims 1 through 10, the lighting fixture includes a grounding terminal, and the grounding terminal and an electrically-conductive member of the light source are electrically connected to each other.

Here, the expression “electrically connected” includes a case in which the electrically-conductive member and the grounding terminal are directly connected to each other and a case in which the electrically-conductive member and the grounding terminal are indirectly connected to each other.

With the above structure, it is possible to prevent the attachment of dust.

### Advantageous Effects of Invention

The present invention provides a light source having an electrically-conductive member provided on at least one of the outer surface and the inner surface of the electrically-insulative and light-transmissive outer shell, and when a grounding terminal of a lighting fixture to which the light source is attached and the electrically-conductive member are electrically connected to each other, the light source is able to discharge an electric charge stored on the outer surface of the outer shell to the outside via the electrically-conductive member.

### BRIEF DESCRIPTION OF DRAWINGS

FIG. 1 is a perspective view of a light source pertaining to Embodiment 1 of the present invention, as viewed from the side facing a base for grounding.

FIG. 2 is a perspective view of the light source, as viewed from the side facing a base for receiving power.

FIG. 3 is a view of the light source for explaining the internal structure of the base for grounding.

FIG. 4 is a partial cross-section diagram of the light source for explaining the structure of an outer shell.

FIG. 5 is a view of the light source for explaining the base for grounding.

FIG. 6 is a view for explaining the light source attached to a lighting fixture.

FIG. 7 is a view for explaining a light source pertaining to Embodiment 2 of the present invention attached to a lighting fixture.

FIG. 8 is a front view of a light source pertaining to Embodiment 3 of the present invention.

FIG. 9 is a partial cross-sectional view of the light source for explaining the structure of an outer shell.

FIG. 10 is a view for explaining a circuit of the light source.

FIG. 11 is a view for explaining the light source attached to a lighting fixture.

### DESCRIPTION OF EMBODIMENTS

### Embodiment 1

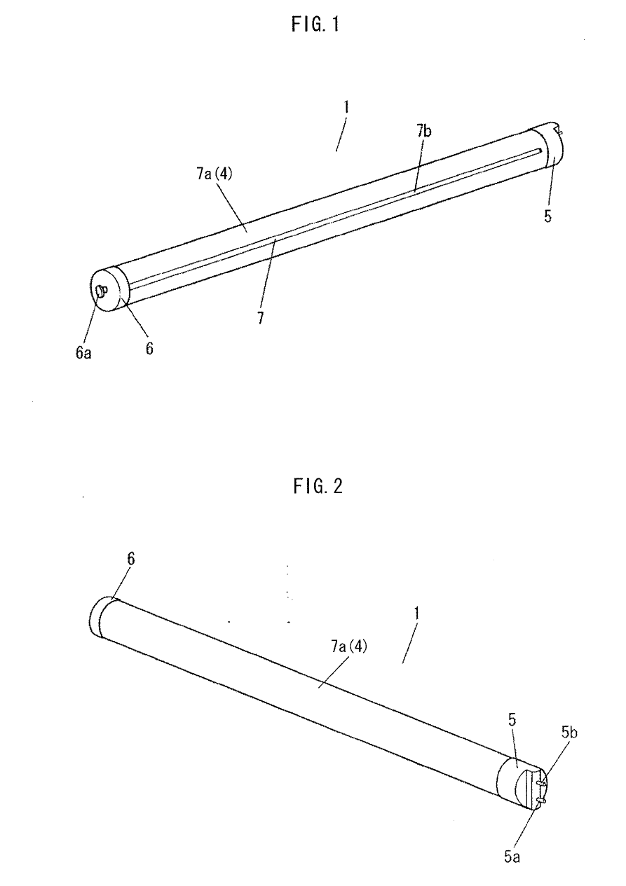

The following describes a light source pertaining to Embodiment 1 of the present invention with reference to FIGS. 1-6.

FIGS. 1 and 2 are perspective views of the light source pertaining to the present embodiment. Such a light source 1 is attached to a lighting fixture, and can be substituted for a conventional straight tube fluorescent lamp, for example.

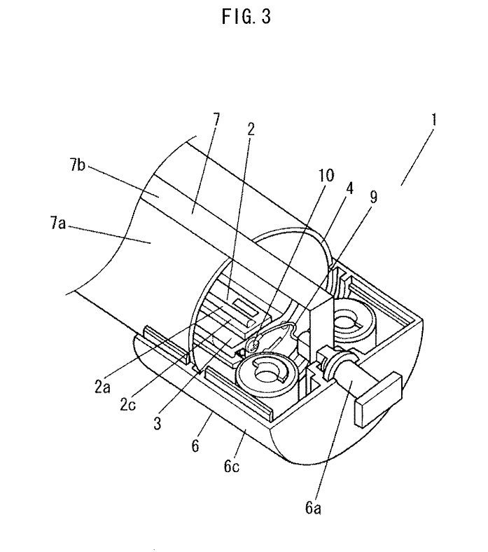

FIG. 3 shows the internal structure of a base for grounding the light source 1, which is described later. LED modules 2 shown in FIG. 3 include a plurality of LED elements (unillustrated), which are semiconductor light-emitting elements, arranged in line on the main surface of an elongated rectangular plate-like mounting substrate 2c. The opposite surface of the mounting substrate 2c is provided with and in contact with a mount 3 made of material with high thermal conductivity, such as aluminum. The mount 3 serves as a heatsink. The LED modules 2, along with the mount 3, are built in the outer shell 4.

Note that since the LED modules 2 and the mount 3 are in contact with each other, heat generated by the LED modules 2 can be effectively conducted to the outer shell 4 via the mount 3. The heat conducted to the outer shell 4 is discharged from the outer surface thereof.

The outer shell 4 is a long and thin cylinder, and made of electrically-insulative and light-transmissive material such as resin, glass or ceramic. On one end of the outer shell 4 is provided with a base 5, and on the other end is provided with a base 6. The base 5 includes two pin terminals 5a and 5b used for receiving power (hereinafter, the base 5 is referred to as “power receiving base”). The base 6 includes one pin terminal 6a that is used for grounding (earthing) and connected to the mount 3 (hereinafter, the base 6 is referred to as “grounding base”).

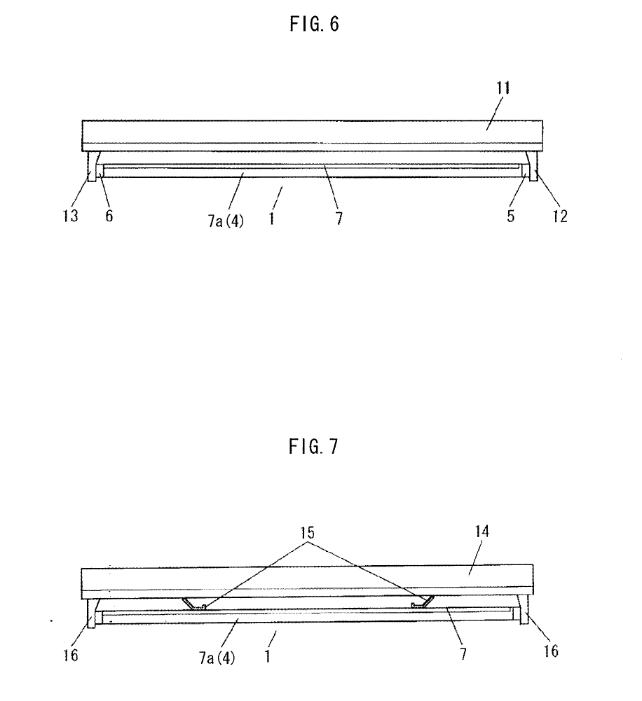

Each of the terminals 5a, 5b and 6a of the bases 5 and 6 should be positioned in a particular direction. When the light source 1 is attached to a lighting fixture 11, a second electrically-conductive member 7b provided on the outer surface of the outer shell 4 faces toward the lighting fixture 11 (see FIG. 6).

The outer shell 4 has an electrically-conductive member 7a on the outer surface or the inner surface thereof or both. In the present embodiment, the first electrically-conductive member 7a is provided on the outer surface. The first electrically-conductive member 7a is a light-transmissive conductive coating made of a conductive metal oxide such as indium tin oxide, zinc oxide, or tin oxide (in this case, the first electrically-conductive member 7a is metal oxide film). The first electrically-conductive member 7a is applied to spread from the one end to the opposite end over the outer surface of the outer shell 4. Even though the outer surface of the outer shell 4 is covered with the first electrically-conductive member 7a, the effect of reduction in luminous flux caused by the electrically-conductive member 7a is suppressed since the first electrically-conductive member 7a made of the metal oxide film is light-transmissive.

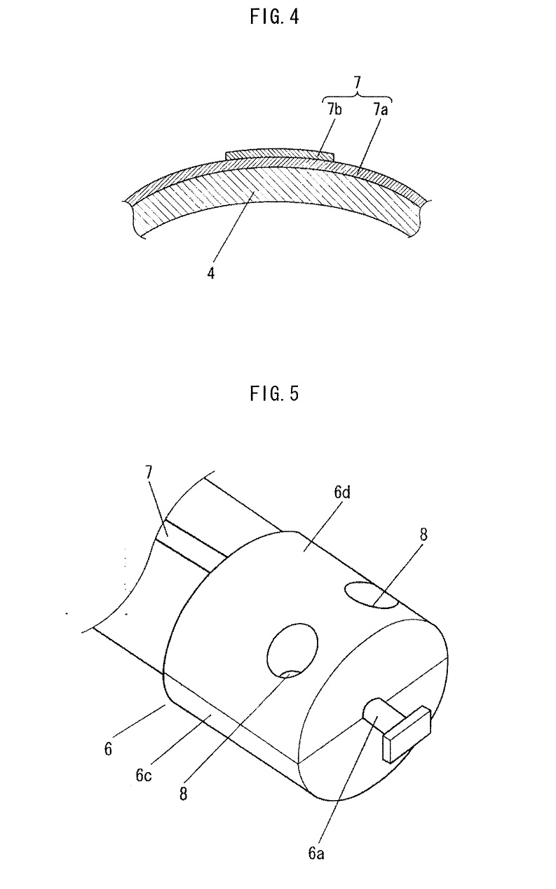

On the first electrically-conductive member 7a (i.e., on the conductive coating), the second electrically-conductive member 7b made of metal is provided. The second electrically-conductive member 7b extends from the terminal 6a of the grounding base 6 on the outer shell 4 in a lengthwise direction thereof, and reaches just before the power receiving base 5. The second electrically-conductive member 7b is fixed to the first electrically-conductive member 7a. The first electrically-conductive member 7a and the second electrically-conductive member 7b are electrically connected to each other, and form an electrically-conductive member 7 (see FIG. 4). The second electrically-conductive member 7b is fixed to the first electrically-conductive member 7a by pressure bonding, with screws or conductive solder, for example.

The first electrically-conductive member 7a, which is the conductive coating, has a thickness from 0.1 μm to 0.5 μm, and resistivity from 1×10⁻⁴ Ωcm to 1×10⁻³ Ωcm. The first electrically-conductive member 7a is formed by a general thin-film forming method such as the sputter method, the deposition method, the sol-gel method and the CVD method. Other methods may be used.

The second electrically-conductive member 7b is a thin-film conductor (conductive film) made of aluminum in the shape of a strip (tape) that is 2 mm in width and 0.5 mm in thickness, for example. In the present embodiment, the second electrically-conductive member 7b is provided at the whole area of the outer shell 4 in the lengthwise direction except for an area of the outer shell 4 close to the power receiving base 5.

As shown in FIG. 3, an end portion of the second electrically-conductive member 7b bends in the grounding base 6 to be close to the central axis of the outer shell 4, and the end portion is connected to the terminal 6a (hereinafter, grounding terminal) inside the grounding base 6.

The bend portion of the second electrically-conductive member 7b that is connected to the grounding terminal 6a may be divided into two parts such that the two parts sandwich the pin terminal 6a, or may be in the shape of a ring through which the terminal 6a passes, for example. In the present embodiment, the second electrically-conductive member is directly electrically connected to the terminal 6a. Alternatively, the electrically-conductive member 7 and the terminal 6a may be electrically connected to each other via another electrically-conductive member.

The first electrically-conductive member 7a is not limited to the conductive coating. For example, a transparent conductive film may be used as the first electrically-conductive member 7a to wrap up the outer shell 4. The transparent conductive film is formed by dry coating a conductive material made of indium tin oxide, zinc oxide, tin oxide, etc., on a resin film made of PET, PES, PC, PAR, etc., by various methods, such as the sputter method, the ion plating method, etc.

The transparent conductive film is generally in the form of a roll and easily wound around the cylindrical outer shell 4. It is therefore possible to increase productivity, and furthermore, when the outer shell breaks, the transparent conductive film prevents the broken pieces of the outer shell from scattering around. In this case, the transparent conductive film is more effective when wrapped around the outer shell 4 so as to expose the conductive coating to the outside.

The first electrically-conductive member 7a constituting the electrically-conductive member 7 may be made of a light-transmissive resin member including at least one of metal particles and conductive particles. The metal particles may be made of copper, gold, silver, aluminum, iron, and alloy composed of these metals. The conductive particles may be made of metal oxide particles made of indium tin oxide, zinc oxide, tin oxide, etc. The light-transmissive resin member is made of silicone resin, etc., and is formed by coating the outer surface of the outer shell 4 with the silicone resin, etc.

In this case, if light-transmissive metal oxide particles are included as an electrically-conductive member, the effect of reduction in luminous flux caused by the electrically-conductive member is suppressed, and the electrically-conductive member has the function of diffusing light. Additionally, if the electrically-conductive member is made of resin including metal particles, the low resistance electrically-conductive member is easily arranged on the outer surface of the outer shell.

The diameter of each of conductive particles may be from several nm to 100 μm. Further, the electrically-conductive member has the function of diffusing light, and diffuses light emitted by the LED modules 2. The diameter of each particle is preferred to be from 1 μm to 100 μm to achieve the function of diffusing light.

The second electrically-conductive member 7b may have adhesiveness. In this case, the second electrically-conductive member 7b is made of conductive resin including conductive particles such as metal or metal oxide, for example. Alternatively, a metal conducting wire is brought into contact with the outer surface of the outer shell 4 as the second electrically-conductive member 7b, and the wire is coated with a transparent adhesive and adhered to the outer shell 4, for example. The conductive particles may be made of copper, gold, silver, aluminum, iron, and alloy composed of these metals, for example. Alternatively, the conductive particles may be made of conductive metal oxide such as indium tin oxide, zinc oxide and tin oxide, or mixed material of these oxide. The diameter of each of conductive particles may be from several nm to 100 μm.

The second electrically-conductive member 7b is not limited to a thin-film conductor made of aluminum described above. For example, the second electrically-conductive member 7b may be formed by a thin-film forming method such as the deposition method of depositing metal such as aluminum, or by plating method.

In order to discharge an electric charge stored on the outer surface of the outer shell 4 to the outside, the lower resistance between the grounding terminal 6a and a point on the outer surface of the outer shell 4 that is electrically farthest from the grounding terminal 6a is more desirable. In other words, the lower resistance value between the grounding terminal 6a and a point on the outer surface of the outer shell 4 that has the highest resistance value is more desirable. It is preferable that the resistance value be 1 MΩ or less, and it is more preferable that the resistance value be 1 kΩ or less.

Although reducing the resistance value to zero is not practical, it is more preferable to reduce the resistance value down to a range of 1Ω to 300Ω. In the present embodiment, the resistance value can be reduced to 100Ω or less by covering the entire outer surface of the outer shell 4 with the electrically-conductive member (to be exact, with the first electrically-conductive member 7a).

As in the present embodiment, by covering a substantially entire part of the outer surface of the outer shell 4 with the first electrically-conductive member 7a and further providing the strip-like second electrically-conductive member 7b made of metal to substantially the whole part of the outer shell 4 in the lengthwise direction, it is possible to reduce the resistance value to 30Ω or less, or further to 1Ω or less.

The outer shell 4 may have an electrically-conductive member at least on the outer surface thereof without having the first electrically-conductive member 7a. That is, only the second electrically-conductive member 7b may constitute the electrically-conductive member 7. Alternatively, only the first electrically-conductive member 7a may constitute the electrically-conductive member 7 without the second electrically-conductive member 7b.

The positional relationship between the first electrically-conductive member 7a and the second electrically-conductive member 7b may be inverted. That is, the second electrically-conductive member 7b may be formed (positioned) on part of the outer surface of the outer shell 4, and the first electrically-conductive member 7a may be formed (applied) on the second electrically-conductive member 7b so as to cover the entire outer surface of the outer shell 4.

The second electrically-conductive member 7 may be formed of a plurality of strip-like members, may spirally wind around the outer shell 4, may branch into two or more, and may be in the form of a net. As the area of the outer shell 4 coated with the electrically-conductive member 7 increases, the above-mentioned resistance value decreases.

Since reflection and absorption of light by the electrically-conductive member 7 reduces the luminous flux, it is more desirable that the electrically-conductive member 7 have a higher light transmittance. By providing an innovation in material, thickness and layer structure of the electrically-conductive members, the electrically-conductive member may have the function of antireflection.

Each of the grounding base 6 and the power receiving base 5 that is provided at either end of the outer shell 4 is formed of two parts made of resin. For example, as shown in FIGS. 3 and 5, the two parts consist of a first part 6c and a second part 6d. The electrically-conductive member 7, the terminal 6a, the outer shell 4a, etc., are arranged in the first part 6c, subsequently the first part 6c is covered by the second part 6d shown in FIG. 5, and the first part 6c is then fixed to the second part 6d by screws 8 so as to be integrated together into one unit. Similarly, the base 5 is formed.

In the present embodiment, one end of the electrically-conductive member 7 (to be exact, the second electrically-conductive member 7b) is in the base 6, and accordingly, the connection area of the electrically-conductive member 7 with the grounding terminal 6a are not seen from an external viewpoint. Therefore, a light source with the high appearance quality can be provided.

Each of the bases 5 and 6 may be a metallic base shaped as a bottomed cylinder, which is fit onto one end of a conventional fluorescent lamp. Such metallic bases are required to be electrically-insulative from the terminals 5a and 5b that are used for receiving power. Alternatively, other types of bases may be used (for example, G13), and new types of bases may be used.

The outer shell 4 pertaining to the present embodiment is a straight tube. As shown in FIG. 1, the outer shell 4 serves as a housing (envelope) that houses the LED modules 2 and the mount 3, which is a heatsink. The outer shell 4 is an elongated cylinder having openings at both ends, and has annular cross section. The outer shell 4 is formed of a light-transmissive member that is electrically-insulative such as a glass tube, a plastic tube, or a ceramic tube.

In the present embodiment, the outer shell 4 has the same size as that of a straight tube with open ends, which is used to form a fluorescent lamp defined by the Japan Industrial Standards (JIS) for example.

The outer surface or the inner surface of the outer shell 4 diffuses light emitted by the LED modules 2 by being partially or entirely treated with opal glass.

As shown in FIG. 3, each of the LED modules 2 is chip on board (COB) type, and a line light source. Each LED module 2 includes the mounting substrate 2c, a plurality of LEDs arranged on the mounting substrate 2c, and a sealing member 2a. The sealing member 2a seals the linearly-arranged LEDs and is made of phosphor-containing resin including silicone resin in which phosphor particles disperse, for example.

In the present embodiment, the plurality of LED modules 2 are arranged in line on the mount 3. Alternatively, only one LED module may be used.

LEDs of each LED module 2 are linearly arranged on the mounting substrate 2c, and on each of the LED modules, eight LED sequences each including three LEDs electrically connected in series are electrically connected in parallel. In the outer shell 4, eight LED modules 2 are arranged in line on the mount 3. The adjacent LED modules 2 are electrically connected to each other. That is, eight LED modules, on each of which the eight LED sequences each including three LEDs connected in series connected in parallel, are connected in series.

When the LEDs are connected as above, one end of each LED sequence and the opposite end of each LED sequence are respectively a high-potential end and a low-potential end, and accordingly, one end of the outer shell 4 is a high-potential end and the opposite end is a low-potential end. Since direct current power flows from one end of the light source 1 to the opposite end of the light source 1 in a fixed direction, the electric field maintains the fixed direction, and this produces an electric charge on the outer surface of the outer shell 4.

As a result, if the outer shell 4 is not covered by (provided with) the electrically-conductive member 7, the outer surface of the outer shell 4 is electrically charged and dust is easily to attach to the outer shell 4. However, since the outer shell 4 is coated with the electrically-conductive member 7, an electric charge is not stored, and it is therefore possible to prevent dust from attaching to the outer shell 4.

That is, when the electric field around the light source 1 maintains the fixed direction, or when an electric charge is easily stored, the present invention is more effective. This applies to the case where a direction of the maintained electric field varies according to the point on the outer shell 4, i.e., when potential within the outer shell 4 is differently distributed.

By preventing dust from attaching to the outer shell 4, it is possible to suppress reduction in luminous flux due to dust, and to provide a high-quality lamp that keep the luminous flux close to the initial level for a long time period. In addition, due to the prevention of the attachment of dust, the maintenance activities and costs for dust removal can be lower, or even unnecessary,

In particular, since the electrically-conductive member 7 includes the first electrically-conductive member 7a formed throughout the outer surface of the outer shell 4 and the strip-like second electrically-conductive member 7b formed on the first electrically-conductive member 7a, the charge stored throughout the outer surface of the outer shell 4 is effectively discharged from the second electrically-conductive member 7b to the outside, via the first electrically-conductive member 7a, which is formed throughout the outer surface of the outer shell 4.

Here, the first electrically-conductive member 7a is continuous in the circumferential direction. Alternatively, the first electrically-conductive member may be continuous on the outer surface of the outer shell 4 in the circumferential direction with the exception of one area that extends in the form of a strip in the longitudinal direction, and the second electrically-conductive member may cover the strip-like area in which the first electrically-conductive member is not formed and part of the first electrically-conductive member adjacent to the strip-like area, for example. In this case as well, it is possible to effectively discharge the charge stored throughout the outer surface of the outer shell 4 from the second electrically-conductive member via the first electrically-conductive member, which is formed throughout the outer surface of the outer shell 4, to the outside of the light source 1.

The mounting substrate 2c may be formed of a ceramic substrate made of alumina or light-transmissive aluminum nitride, an aluminum substrate made of aluminum alloy, a transparent glass substrate, and a flexible printed circuit (FPC) made of resin, for example.

The mounting substrate 2c is provided with power receiving/supplying units (external connection terminals) (unillustrated) that directly supply power to the LEDs. The external connection terminals are provided at both ends of the mounting substrate 2c to supply power, via a land (unillustrated), to both ends of the plurality of LEDs that are linearly arranged.

The power receiving base 5 contains a lighting circuit (unillustrated) including a circuit that converts alternating voltage to direct voltage. The pair of terminals 5a and 5b provided at the power receiving base 5 receive alternating power supplied from a commercial alternating power source, and supply alternating power to the lighting circuit. Subsequently, the power is supplied to the mounting substrate 2c via the lighting circuit.

One of the external connection terminals on the mounting substrate 2c at the high-potential end is connected to the lighting circuit via an insulation-covered lead wire (unillustrated). Another one of the external connection terminals on the mounting substrate 2c at the low-potential end is provided far from the power receiving base 5, and accordingly this terminal is connected to one end of a different lead wire (unillustrated). In the neighborhood of the grounding base 6, the different lead wire is folded back toward the power receiving base 5, and the different lead wire runs along the back surface of the mount 3, such that another end of the different lead wire is connected to the lighting circuit positioned in the power receiving base 5.

The mount 3, which is a heatsink on which the mounting substrate 2c is mounted, is electrically connected to the terminal 6a of the grounding base 6 via an insulation-covered lead wire 9, and discharges an electric charge stored on the mount 3 by lighting. The lead wire 9 and the mount 3 are pressed and fixed to each other with a screw 10, but may be fixed to each other by using other methods.

The outer shell 4 and the mount 3 are bonded together with adhesive (unillustrated). From a perspective of heat dissipation, it is preferable that the adhesive have thermal conductivity that is 1 W/m·K or greater, and from a perspective of weight reduction, it is preferable that the adhesive have a specific gravity that is 2 g/cm³ or less. The adhesive is made of silicone resin or cement, for example.

FIG. 6 shows the light source 1 attached to a lighting fixture 11. The power receiving base 5 is inserted into a socket 12 for supplying power, and the grounding base 6 is inserted into a socket 13 for grounding (hereinafter, this socket is referred to as “grounding socket”).

The socket 12 for supplying power has the function of supplying power to the two pin terminals 5a and 5b for receiving power. The socket 13 for grounding has the function of grounding the grounding terminal 6a to a fixture and the like.

From the socket 12 for supplying power, alternating or direct power (here, alternating) is supplied to the power receiving base 5. When the grounding base 6 is electrically connected to a grounding terminal (unillustrated) contained in the grounding socket 13 that corresponds with the grounding terminal 6a of the grounding base 6, a resistance value between the base 6 and the connected grounding terminal is set low enough for grounding.

A resistance value at a point on the outer surface of the outer shell 4 that is electrically farthest from the unillustrated grounding terminal contained in the grounding socket 13 is substantially the same as that from the grounding terminal 6a. Since the grounding terminal 6a of the light source 1 is electrically connected to the unillustrated grounding terminal contained in the grounding socket 13, the grounding terminal contained in the grounding socket 13 is electrically connected to the electrically-conductive member 7, and the charge stored on the outer surface is discharged (moves to the grounding socket 13). As a result, dust is prevented from attaching to the light source 1.

Due to the prevention of the attachment of dust, the maintenance activities and costs for dust removal can be lower, or even unnecessary. The lighting apparatus including the light source 1 and the lighting fixture 11 offers the above effects.

When the grounding terminal (unillustrated) contained in the grounding socket 13 is electrically connected to the grounding terminal (unillustrated) of the lighting fixture 11, the grounding terminal contained in the grounding socket has the same potential as the lighting fixture 11. This improves the effect of preventing the attachment of dust.

When the light source 1 is attached to the lighting fixture 11, the second electrically-conductive member 7b provided on the outer surface of the outer shell 4 faces toward the lighting fixture 11. That is, when the lighting fixture 11 attached to the ceiling is viewed from below, the second electrically-conductive member 7b is behind the outer shell 4 and is not seen.

In the present embodiment, the mount 3 is housed in the tubular outer shell 4, but is not limited to this. For example, the mount itself may be configured as part of a body, and a surface of the mount on which the LED modules are not mounted may be the outer surface. That is, the outer shell may be configured with a metal body and a light-transmissive outer shell. The metal body is a mount-cum-body made of metal such as aluminum with a semicircular cross-section. The light-transmissive outer shell is a cap with a substantially semicircular cross-section, and is attached to the metal body to cover the LED modules. In other words, the metal body and the light-transmissive outer shell may constitute the entire body of the lamp (i.e., outer shell). In this case, the metal body and the terminal of the grounding base are connected to each other with a lead wire, for example.

Although description has been made on the straight tube LED lamp receiving power from the one end thereof, the LED lamp may receive power from both ends thereof. In this case, each of both bases has one terminal for receiving power, and at least one of the bases may have a terminal for grounding.

In the present embodiment, the base 5 includes the pair of terminals for receiving power, and the other base includes the terminal for grounding. Alternatively, a member attached to one end of the outer shell may have a pair of terminals for receiving power and a terminal for grounding, and this member may be used as a base. In this case, a lid may be fit to the other end of the outer shell so as to close the other end.

Further, the terminals for receiving power and the terminal for grounding may be provided at any point on the outer shell other than the ends thereof. To be specific, any one of these terminals may be provided at the central part of the outer shell. To be more specific, a fixture grounding terminal (15) of a lighting fixture 14 in Embodiment 2 described later may be attached to the electrically-conductive member of the light source, for example.

Further, the bases 5 and 6 in the present embodiment include the terminals at the surfaces of the both ends of the bases each of which is shaped as a bottomed cylinder and formed of the two integrated part made of resin. Alternatively, the terminals may be provided on circumferential surfaces of the bases.

### Embodiment 2

The following describes a light source pertaining to Embodiment 2 of the present invention with reference to FIG. 7. The present embodiment is different from Embodiment 1 according to which the base 6 has the grounding terminal 6a. In the present embodiment, the lighting fixture 14 is provided with a grounding terminal. Here, the light source is the same light source 1 described in Embodiment 1.

Hereinafter, the grounding terminal provided at the lighting fixture 14 is referred to as “fixture grounding terminal” such that this terminal can be distinguished from the grounding terminal provided at the base in Embodiment 1. The fixture grounding terminal 15 has resilience and electrical conductivity, and is made of plate-like phosphor bronze, etc., with a bent portion.

In the present embodiment, the fixture grounding terminal 15 is in contact with the electrically-conductive member 7 provided on the outer surface of the outer shell 4 of the light source 1 when the light source 1 is attached to the lighting fixture 14.

Using the length of the light source 1 as a reference, the fixture grounding terminal 15 is attached to a point that is one fourth from each end of the light source 1.

The resilience of the fixture grounding terminal 15 enables close contact between the fixture grounding terminal 15 and the outer surface of the outer shell 4, and the fixture grounding terminal 15 is electrically connected to the electrically-conductive member 7, which can discharge a stored charge.

According to the lighting fixture 14 pertaining to the present embodiment, the fixture grounding terminal 15 is in contact with intermediate points on the long and thin outer shell 4 in the longitudinal direction thereof. Accordingly, the distance from the fixture grounding terminal 15 to a point on the electrically-conductive member 7 that is electrically farthest from the fixture grounding terminal 15 on the outer surface of the outer shell 4 can be short.

That is, the electric resistance between the fixture grounding terminal 15 and a point on the electrically-conductive member 7 that is farthest from the fixture grounding terminal 15 can be small.

To be specific, when the grounding terminal 6a of the base 6 is used as a grounding terminal as in Embodiment 1, a point that is farthest from the grounding terminal is an end of the electrically-conductive member 7 close to the base 5. Therefore, the distance between the grounding terminal and the point that is farthest from the grounding terminal is substantially the full length of the electrically-conductive member 7.

In contrast, when the fixture grounding terminal 15 is in contact with the electrically-conductive member 7 at the intermediate points thereof, as in Embodiment 2, the distance between the grounding terminal and a point that is farthest from the grounding terminal is shorter than the full length of the electrically-conductive member 7. The distance is shorter than the distance of Embodiment 1, and the electric resistance therebetween in Embodiment 2 is smaller than that in Embodiment 1.

For example, when the fixture grounding terminal 15 is arranged to be in contact with the midpoint of the light source 1 in the longitudinal (tube axis) direction of the light source 1, points that are farthest from the grounding terminal are both ends close to the base 5 and the base 6 on the electrically-conductive member 7. Therefore, the distance between the grounding terminal and the point that is farthest from the grounding terminal is substantially the half of the electrically-conductive member 7. That is, compared to Embodiment 1, the electric resistance value therebetween can be halved.

Further, in the present embodiment, the fixture grounding terminal 15 is attached to a point that is one fourth from each end of the light source 1, using the length of the light source 1 as a reference. Therefore, the distance between the grounding terminal and the point that is farthest from the grounding terminal is substantially one fourth of the electrically-conductive member 7. Accordingly, compared to Embodiment 1, the electric resistance value therebetween can be reduced to one fourth.

As a result, it is possible to more effectively discharge an electric charge stored on the surface of the outer shell 4, and a greater effect of preventing the attachment of dust can be obtained. If a plurality of fixture grounding terminals 15 are attached, the effect can be enhanced.

The present structure is also effective to a lighting fixture formed by altering a fixture for a conventional fluorescent lamp, since the socket 16 does not need to include a grounding terminal. As a matter of course, the present structure may be used together with Embodiment 1 shown in FIG. 6.

### Embodiment 3

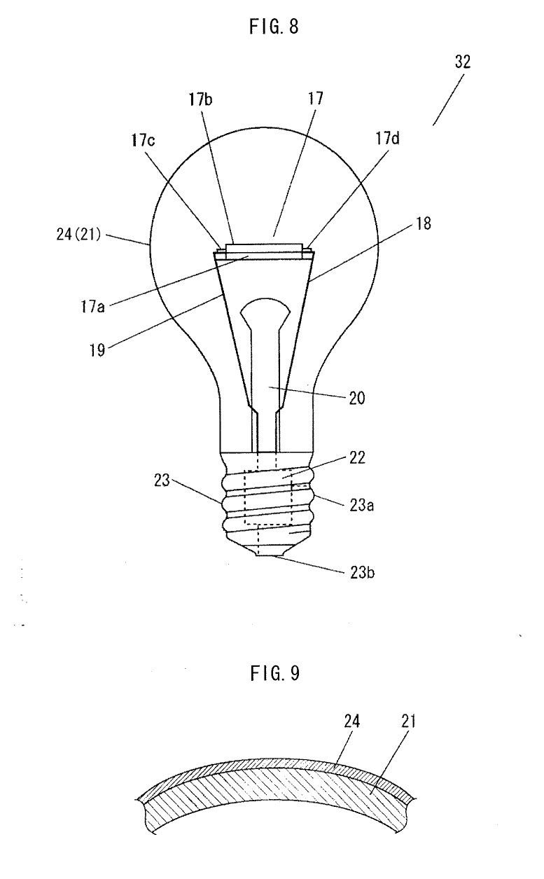

The following describes the overall structure of a light source 32 pertaining to Embodiment 3 of the present invention that uses an LED, with reference to FIGS. 8-11. A light source pertaining to Embodiment 3 of the present invention shown in FIG. 8 includes an LED module 17, two lead wires 18 and 19 for supplying power to the LED, a stem 20, a light-transmissive outer shell 21, a circuit 22 having electronic components, and a base 23. The circuit 22 and the lead wires 18 and 19 for receiving power inside the base 23 are indicated by a dotted line.

The LED module 17 is made up of a rectangular plate-like substrate 17a on which are mounted a plurality of LEDs in line. Substantially at the center of the hollow outer shell 21 therein, the LED module 17 is housed.

Both ends of the LED module 17 are supported by the two lead wires 18 and 19 for supplying power, for example. The lead wires 18 and 19 for supplying power are supported by the stem 20. An opening of the outer shell 21 is covered by the stem 20. The base 23 is attached to the outer shell 21 so as to hide the covered part.

The base 23 contains the lighting circuit 22 that converts alternating voltage to direct voltage, and supplies power to the LED. One end of each of the two lead wires 18 and 19 extending from the stem 20 to the outside of the outer shell 21 is connected to the lighting circuit 22. A pair of lead wires extend from the lighting circuit 22, and one end of each of the lead wires is connected to the base 23. To be specific, one end of one of the pair of lead wires is electrically connected to a screw 23a of the side surface of the base, and one end of the other one of the pair of lead wires is electrically connected to an eyelet 23b of the bottom of the base.

The outer shell 21 is made of glass, which is electrically-insulated material. FIG. 9 shows a partial cross section of the outer shell 21. The outer surface of the outer shell 21 is entirely covered with an electrically-conductive member 24, which is a light-transmissive and electrically-conductive film, with the exception of an area that falls within 10 mm from the base 23.

The area that falls within 10 mm from the base 23 is not covered with the electrically-conductive member in order to electrically insulate the base 23 and the electrically-conductive member 24. The electrically-conductive member 24 is configured and formed in the same manner as the first electrically-conductive member 7a in Embodiment 1, and therefore a description thereof is omitted.

The LED module 17 pertaining to the present embodiment is made up of a mounting substrate made of ceramic on which are mounted 12 LEDs (unillustrated) emitting blue light in line, and a light-transmissive resin sealing member 17b including phosphor particles (unillustrated) such as YAG seals the LEDs. The LEDs are electrically connected in series to one another by a conductive pattern (unillustrated) which are provided on the mounting substrate, and Ag wires (unillustrated).

The LED module 17 includes power receiving terminals 17c and 17d provided at both ends thereof. The power receiving terminals 17c and 17d are electrically and mechanically connected to ends (the other ends) of the lead wires 18 and 19 for receiving power, respectively, through the use of solder.

Each of the lead wires 18 and 19 that supply power to the LED module 17 may be a single wire, or may be a composite wire formed by joining an inner lead wire, a Dumet wire, and an outer lead wire in this order. In each case, it is preferable that the lead wires 18 and 19 be strong enough to support the LED module 17.

The inner lead wire extends from the stem 20 to the inside of the outer shell 21 and is connected to the power receiving terminals 17c and 17d of the LED module. The outer lead wire extends to the outside of the outer shell 21 (inside of the base 23) and is connected to the lighting circuit 22 for driving. It is preferable that each of the interior lead wire and the outer lead wire be made of a metal wire including copper, which is highly thermally conductive.

The stem 20 is made of soft glass, for example. When the lead wires 18 and 19 for receiving power are made of the above composite wires, an intermediate part made of a Dumet wire is sealed by the stem 20. Since the stem 20 is sealed at the opening of the spherical outer shell 21, the inside of the outer shell 21 and the outside of the outer shell 21 are electrically connected via the lead wires 18 and 19 while the airtightness in the outer shell 21 is kept.

The outer shell 21 is in the A-type shape (JIS C7710) like a general incandescent bulb. To be specific, the outer shell 21 has a sphere and a tube part, and the diameter of the tube part decreases as the distance from the center of the sphere increases. The outer shell 21 is made of transparent silica glass, for example, and the LED module 17 arranged at the center of the outer shell 21 can be seen from the outside of the outer shell 21. The shape of the outer shell 21 is not limited to the A-type shape, and may be selected from the G-type shape, the E-type shape or the like in accordance with the intended use of the light source 32.

In the present embodiment, the outer shell 21 and the stem 20 are made of glass, for example. In accordance with the intended use of the light source 32, the outer shell 21 and the stem 20 may be made of resin such as acryl, and the outer shell 21 may be made of glass and the stem may be made of resin.

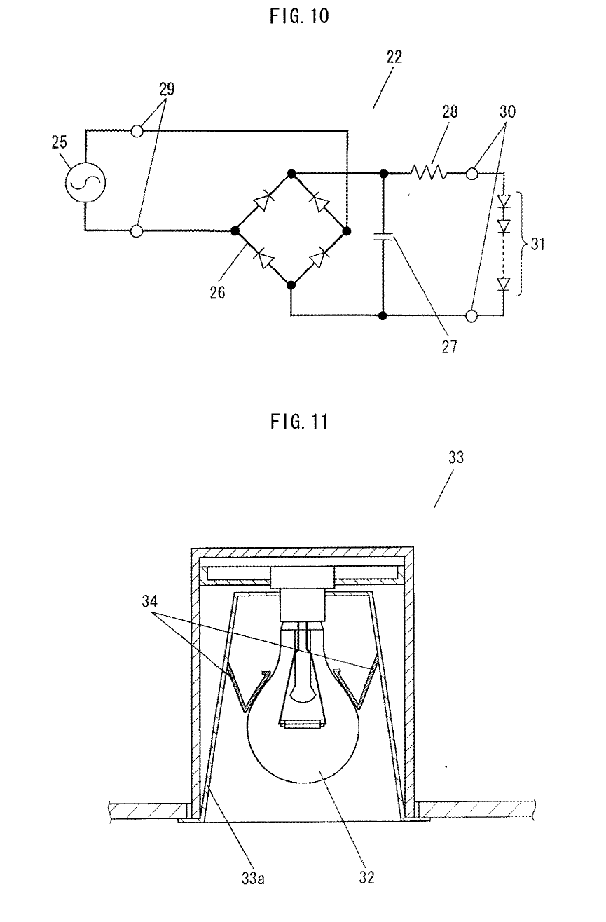

FIG. 10 shows the structure of a lighting circuit. The lighting circuit 22 containing electronic components includes a rectifying circuit, a smoothing circuit, a current adjustment circuit and the like. To be specific, the rectifying circuit is realized by a diode bridge 26, the smoothing circuit is realized by a capacitor 27, and the current adjustment circuit is realized by a resistance 28. These circuits are housed in the base 23.

Input terminals of the diode bridge 26 act as input terminals 29 of the lighting circuit 22, and one end of the capacitor 27 and one end of the resistance 28 act as output terminals 30 of the lighting circuit 22. The input terminals 29 are electrically connected to the base 23. One of the input terminals 29 is connected to the screw 23a of the side surface of the base, and the other of the input terminals 29 is connected to the eyelet 23b of the bottom of the base.

The output terminals 30 of the lighting circuit 22 are connected to the outer lead wires of the lead wires 18 and 19 for receiving power. That is, the output terminals 30 are electrically connected to the LED module 17 (LED chip sequence 31).

In the present embodiment, the base 23 is an E26 base. The base 23 is attached to a lighting fixture (33) having a socket for an E26 base connected to a commercial alternating power source 25.

In the present embodiment, the E26 base is used, for example, but the base is not limited to this. A base different in size and shape may be selected in accordance with the intended use. Further, the power source is not limited to the commercial alternating power source, and may be a direct current power source, i.e., battery (in this case, the structure of the above lighting circuit 22 is changed). Furthermore, the lighting circuit is not limited to the above rectifying circuit, for example, and a light adjusting circuit and a boost circuit may be selected and combined as appropriate.

FIG. 11 shows the light source 32 pertaining to Embodiment 3 attached to a lighting fixture 33. The lighting fixture 33 is a light fixture generally called a downlight. When the lighting fixture 33 is attached to the ceiling, light emitted from the light source 32 is reflected by a reflector 33a and the floor is irradiated with the reflected light as a spotlight.

The reflector 33a is provided with fixture grounding terminals 34. When the light source 32 is attached to the lighting fixture 33, the fixture grounding terminals 34 and the electrically-conductive member 24 provided on the outer surface of the outer shell 21 are electrically connected to each other.

The fixture grounding terminals 34 have resilience and electrical conductivity, and are made of plate-like phosphor bronze, etc., with a bent portion. This causes the fixture grounding terminals 34 to closely attach to (are in contact with) the electrically-conductive member 24 provided on the outer surface of the outer shell 21, and to be electrically connected to the electrically-conductive member 24. As a result, an electric charge stored on the outer surface is discharged, and dust is prevented from attaching to the outer surface. The lighting apparatus including the light source 32 and the lighting fixture 33 offers the above effects.

According to the light source and the lighting fixture pertaining to the present invention in each embodiment, the light source 1 is provided with the terminal 6a having the function of grounding and the lighting fixture 33 is provided with the terminals 34 having the function of grounding so as to discharge an electric charge stored on the light sources 1 and 32 via the lighting fixture to the outside of the light sources 1 and 32. Therefore, it is possible to prevent dust, etc., from attaching to the light sources 1 and 32.

Although description has been made on an LED lamp substituted for a straight tube fluorescent lamp or a typical bulb in each embodiment, the present invention can be adopted in an LED lamp substituted for a conventional circular fluorescent tube or a single-based fluorescent lamp.

Further, even when a direct current power source is connected, the light source is prevented from being charged, and it is therefore possible to prevent dust, etc., from attaching to the light source. Further, even when the light-emitting elements are driven by a direct current, the light source is prevented from being charged, and it is therefore possible to prevent dust, etc., from attaching to the light source.

Furthermore, the electric resistance between a point on the electrically-conductive member 24 that is electrically closest to the grounding terminals 34 and a point on the electrically-conductive member 24 that is electrically farthest from the grounding terminals 34 is within a range from 1Ω to 1 MΩ. It is therefore possible to discharge an electric charge stored on the outer surface of the outer shell to the outside.

In each embodiment, the electrically-conductive members 7a and 24 are respectively arranged on a certain area of the outer surface of the outer shells 4 and 21. Alternatively, the electrically-conductive members 7a and 24 may be arranged only on a certain area irradiated with light (which is part of the outer surface of the outer shell), or the outer surface of the outer shell may be provided with first annular electrically-conductive members at a certain distance therebetween in the longitudinal direction of the outer shell, and a second electrically-conductive member may be further provided in the longitudinal direction so as to connect the first electrically-conductive members to one another, for example.

Further, although the first electrically-conductive member 7a and the electrically-conductive member 24 are arranged throughout the outer surface of the outer shells 4 and 21 in the embodiments, an electrically-conductive member may not be provided at a certain area. For example, the electrically-conductive member may have a plurality of through holes that are evenly (regularly) arranged.

Further, although the electrically-conductive members 7 and 24 in the embodiments are provided on the outer surface of the outer shells 4 and 21, the electrically-conductive members 7 and 24 may be provided on the inner surface of the outer shells 4 and 21.

That is, when the electrically-conductive member is provided on the inner surface of the outer shell, an electric charge stored on the inner surface is discharged to the outside of the light source via the grounding terminal, and the lighting fixture and the electrically-conductive member have the same electric potential. As a result, the outer surface of the electrically-insulative outer shell sandwiched by the lighting fixture and the electrically-conductive member has the same electric potential, and it is therefore possible to prevent dust from attaching to the outer shell.

The effect of providing the electrically-conductive member on the inner surface of the outer shell is that since the electrically-conductive member cannot be touched from the outside, disconnection of the electrically-conductive member can be prevented.

Further, if electrically-conductive members are provided on both the outer surface and the inner surface of the outer shell, even when the electric resistance value of the electrically-conductive member on the outer surface becomes high due to disconnection, etc., the electrically-conductive member on the inner surface can prevent reduction of the effect of preventing the attachment of dust.

In the above embodiment, each of the LED modules 2 and 17 is chip on board (COB) type, and the LED modules 2 and 17 respectively include the mounting substrates 2c and 17a on which LED chips (bare chips) are directly implemented. The LED modules 2 and 17 are not limited to this. For example, the LED module may be a package type, i.e., a surface mount device (SMD). In this case, the LED chips are implemented within a cavity molded by resin, etc., and the cavity is sealed by phosphor-containing resin.

Further, although an LED has been shown as a semiconductor light-emitting element in the above embodiments, a semiconductor laser and an organic electro luminescence (EL) may be used.

In addition to the above, a variety of modifications conceived by the person skilled in the art without departing from the scope of the present invention are included in the scope of the present invention. Further, without departing from the spirit of the present invention, any combination of the components in the embodiments may be used.

### INDUSTRIAL APPLICABILITY

The light source pertaining to the present invention is able to keep the luminous flux close to the initial level for a long time period by preventing the outer surface of the outer shell from being charged, and reducing the attachment of dust due to an electric charge, and is able to reduce or eliminate the maintenance activities and costs for dust removal.

### REFERENCE SIGNS LIST

1, 32 light source

2, 17 LED module

3 mount

4, 21 outer shell

5, 6, 23 base

5a, 5b, 6a terminal

7, 7a, 7b, 24 electrically-conductive member

8, 10 screw

9, 18, 19 lead wire

11, 14, 33 lighting fixture

12, 13, 16 socket

15, 34 fixture grounding terminal

20 stem

22 circuit

26 diode bridge

27 capacitor

28 resistance

29 input terminal

30 output terminal

31 LED chip sequence

1-11. (canceled)

12. A light source to be attached to a lighting fixture, comprising:
a light-emitting element;
an outer shell that houses the light-emitting element; and
a base provided at the outer shell, wherein
the outer shell is made of electrically-insulative and light-transmissive material,
the outer shell has an electrically-conductive member provided on at least one of an outer surface and an inner surface thereof, and
the electrically-conductive member is electrically connected to a grounding terminal of the lighting fixture.

13. The light source of claim 12, wherein
electric resistance between the grounding terminal and a point on the electrically-conductive member that is electrically farthest from the grounding terminal is within a range from 1Ω to 1 MΩ.

14. The light source of claim 12, wherein
the electrically-conductive member is made of a light-transmissive metal oxide coating.

15. The light source of claim 12, wherein
the electrically-conductive member is made of light-transmissive metal oxide particles.

16. The light source of claim 12, wherein
the electrically-conductive member is made of metal particles.

17. The light source of claim 12, wherein
the electrically-conductive member is made of metal.

18. The light source of claim 12, wherein
the electrically-conductive member diffuses light.

19. The light source of claim 12, wherein
the electrically-conductive member is made of a transparent conductive film.

20. The light source of claim 12, wherein
the electrically-conductive member includes a light-transmissive metal oxide coating and a strip-like conductive coating, the light-transmissive metal oxide coating being provided at an area of the outer surface of the outer shell not covered with the base, and the strip-like conductive coating extending in a longitudinal direction of the outer shell on an upper surface of the light-transmissive metal oxide coating.

21. The light source of claim 12, wherein
the base has a grounding terminal connected to the grounding terminal of the lighting fixture, and
the electrically-conductive member is connected to the grounding terminal of the base.

22. The light source of claim 20, wherein
the base has a grounding terminal connected to the grounding terminal of the lighting fixture, and
the electrically-conductive member is connected to the grounding terminal of the base.

23. A lighting apparatus comprising: a light source; and a lighting fixture to which the light source is detachably attached, wherein
the light source is the light source of claim 12, the lighting fixture includes a grounding terminal, and the grounding terminal and an electrically-conductive member of the light source are electrically connected to each other.

24. A lighting apparatus comprising: a light source; and a lighting fixture to which the light source is detachably attached, wherein
the light source is the light source of claim 21, the lighting fixture includes a grounding terminal, and the grounding terminal and an electrically-conductive member of the light source are electrically connected to each other.
